(19) United States
(12) Patent Application Publication
(10) Pub. No.: US 2004/0260635 A1
(43) Pub. Date: Dec. 23, 2004

(54) Financial records maintenance system

(76) Inventor: Ahmed Al-Zaiter, Coulby (GB)

Correspondence Address: GATES & COOPER LLP, HOWARD HUGHES CENTER, 6701 CENTER DRIVE WEST, SUITE 1050, LOS ANGELES, CA, 90045, US

(21) Appl. No.: 10/481,686

(22) PCT Filed: Oct. 1, 2002
(86) PCT No.: PCT/GB02/04435

(30) Foreign Application Priority Data
Oct. 4, 2001 (GB) 0123958.1

(51) Int. Cl. G06F 17/60

(52) U.S. Cl. 705/35

(57) ABSTRACT

The present invention relates to a computer system for maintaining financial records and a method for maintaining such records.

The present invention relates to a computer system for maintaining financial records and a method for maintaining such records.

In a typical business, large amounts of financial data must be recorded and processed to meet various demands on the business, including monitoring financial performance, managing a payroll, dealing with the taxation authorities and delivering information to auditors. For many years large companies have had sophisticated financial records systems capable of delivering whatever management information, audit reports and the like required. Such large companies generally have a finance director with the responsibility of overseeing the operation of the business by reference to the output of the financial records system.

In smaller businesses, and in particular in small businesses with a turnover of less than say one million pounds per year, many of the same issues addressed by the sophisticated financial records systems of large companies also arise but the infrastructure in terms of both systems and personnel is absent. It is simply not practical for small businesses to have on their staff a highly paid person capable of performing the duties of a finance director. It is also not possible for small businesses to invest in expensive financial records systems or the trained staff to run such systems. Traditionally small businesses relied upon purely paper-based financial records systems which were relatively simple to use but were not capable of providing sophisticated outputs in terms of management information or audit and tax reports. Generally management information was largely absent and the person responsible for the wellbeing of the business had great difficulty in picking up changes in the financial circumstances of the business in a timely manner. Typically, underlying problems would only emerge after a year-end audit the result of which might be made available only many months after the occurrence of a previously undetected change in circumstances.

The traditional manual financial records systems have now largely been replaced by computerised systems. Generally such systems are in the form of applications loaded onto simple computer systems run in-house by the business. In some cases such applications are accessed over the Internet, the user entering data onto a remote computer run by a financial records service provider. Such an approach has its advantages in terms of system maintenance, storage of back-up copies of data, system availability and the like but in essence do no more than simulate simple in-house systems. Even when such systems are used, the problem arises of enabling the business manager to review the data and derive from it management information in a format which is useful to their business. This problem can be overcome by in effect out-sourcing the job perform in a large company by a finance director, for example by hiring the time of a chartered accountant who periodically visits the business to review the recorded financial information. Typically a business will look to its auditors to provide an individual accountant to deliver this service, but even in such circumstances the costs involved can be considerable and the visiting accountant cannot deliver the day to day monitoring service which would be expected of an in-house finance director.

Thus looking from the point of view of the manager of a small business, existing systems make it difficult to access support in a cost-effective manner. The present circumstances also represent a problem to small or medium sized firms of financial service providers. Whereas large firms of for example chartered accountants have the resources to develop sophisticated systems to support their clients, smaller firms of financial service providers find it difficult to deliver sophisticated support systems to their clients in a cost effective manner. In particular, setting up on-line systems cannot normally be justified as the costs inherent in the establishment of such systems cannot be spread over many users.

It is an object of the present invention to address the problems outlined above.

According to the present invention, there is provided a computer system for monitoring financial records for a plurality of users and for giving a plurality of mutually independent financial service providers selective access to the financial records, the system comprising a database partitioned into areas each of which is allocated to a respective user, a processor for writing data to and reading data from the database, computer network connections coupling the processor to each user and each financial service provider, a user access control system which is arranged to give a user access via the processor only to the respective data storage area such that each user can only update and read financial data stored in the respective data storage area, and a financial service provider access control system which is arranged to give a financial service provider at least read access via the processor to a data storage area only if that financial service provider is authorised by the user to which that data storage area has been allocated.

In a system in accordance with the invention, a central service provider (hereinafter the financial records service provider or FRSP) can make available to users facilities to enable users to maintain their own financial records and in addition can enable a user to select a financial service provider (hereinafter FSP) to monitor or interact in any desired manner with the user's financial records. Similarly, FSPs can offer to their clients the possibility of their clients becoming users of the system whilst continuing to use the services of the FSP. The service provided by the FSP could be minimal, for example no more than an ability to read data when asked to produce a year-end audit, or substantial, for example to enable the FSP to both monitor and amend the financial records, to analyse the significance of the recorded data and to advise the user of the outcome of that analysis. Of course a user could simply use the system for records keeping, but it is highly likely that users would prefer to also involve an FSP, notably the FSP that most users will already have engaged for audit and other purposes.

From the user's point of view, not only does the system in accordance with the invention make it possible to maintain records in an efficient manner but in addition provides a valuable channel of communication with an FSP. For an FSP, the system makes it possible for that FSP to offer a level of sophistication in on-line systems which would be difficult to justify if developed for that FSP alone.

Security of data will of course be an issue but providing the FRSP establishes appropriate security provisions the necessary levels of security should be maintainable without too much difficulty. It may be the case however that a particular user would not like the idea of their financial data being mixed with financial data from other sources on a common storage device such as a disk drive and in such circumstances it might be appropriate to store all data related to one user on a single storage device. Generally however this would not be necessary and indeed would make efficient use of storage space more difficult.

As a minimum, the FSPs must be provided with the ability when authorised to read data from the authorising user's data storage area. In addition however the FSPs may be authorised by the user to have write access to the user's data storage area. E-mail infrastructure may also be provided to enable a secure exchange of messages between the user and the financial service provider authorised to access that user's data storage area. Accounts related messages could then be passed on a secure e-mail system which is one of the services offered by the FRSP rather than using for example a general-purpose networked e-mail system the security of which is difficult to maintain.

Infrastructure may also be provided to enable the open exchange of messages between different users and financial service providers. This would enable the service operator (FRSP) to monitor the perceptions of the users and FSPs to the service being provided.

Generally the system will make available applications to provide different services with users selecting only those services of interest to them. Examples of possible services are: payroll, sales, customer records, tax, bank accounts, credit card accounts, petty cash, supplier records, pensions, cash flow and budgets. In addition to providing predetermined applications which may be selected by users, the system may also be designed to accommodate applications input by a user or a user's financial service provider so that users could take advantage of the system in accordance with the present invention without having to change their current accounts applications to match those provided on the system. A user could thus take up the service offered by an operator of a system in accordance with the present invention without the difficulties associated with switching from existing accounting systems.

Users and FSPs could be connected to the system in any convenient manner but typically the connection will be via the Internet.

In addition to the computer system as defined above, the invention also provides a method for maintaining financial records for a plurality of users and for giving a plurality of mutually independent financial service providers selective access to the financial records, wherein a database is established and partitioned into areas each of which is allocated to a respective user, a processor is connected to the database for writing data to and reading data from the database, the processor is coupled by the network connections to the users and financial service providers, users are given access via the processor only to storage areas allocated to them, and financial service providers are given access via the processor to a storage area only when authorised by the respective user.

An embodiment of the present invention will now be described, by way of example, with reference to the accompanying drawings, in which;

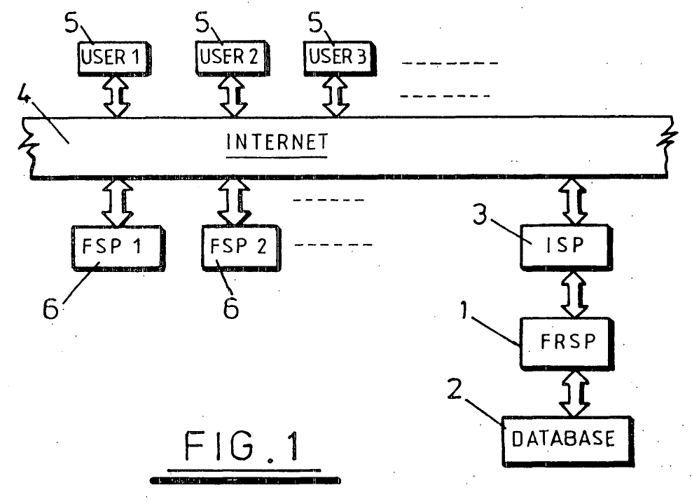

FIG. 1 is a schematic representation of a system in accordance with the present invention;

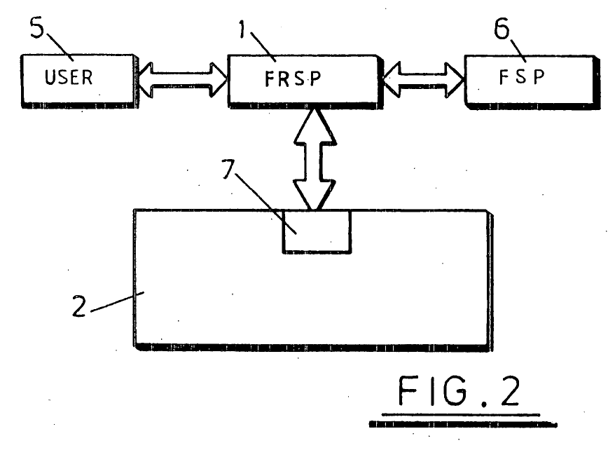

FIG. 2 is a schematic illustration of the exchange of data and applications between an FRSP, a user and an FSP;

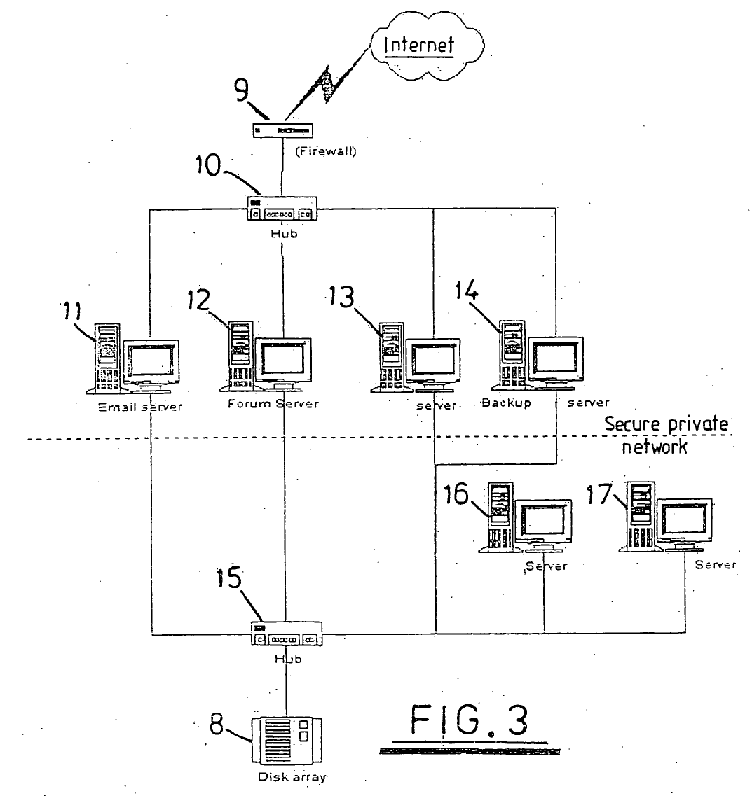

FIG. 3 is a schematic representation of hardware provided by the FRSP;

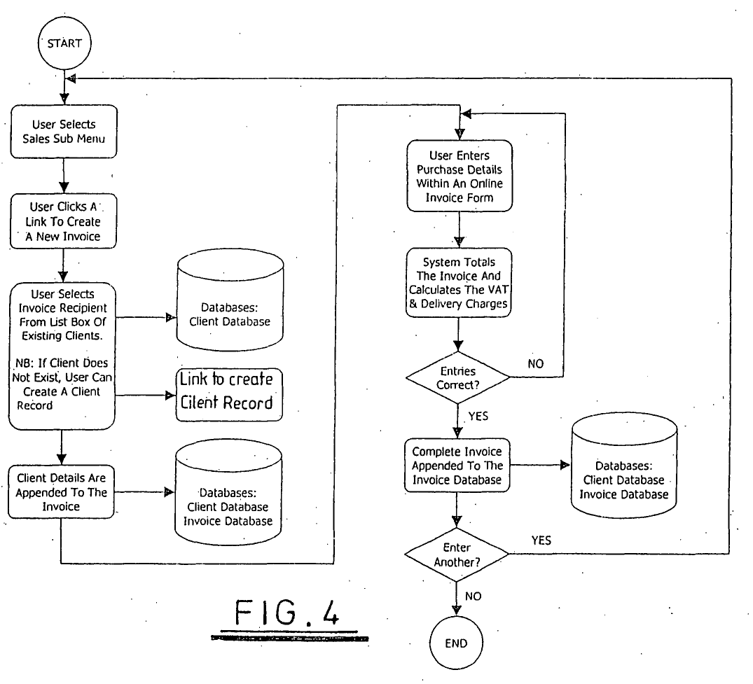

FIGS. 4 to 7 are flow diagrams illustrating the manner in which a user will write data to and read data from a database storage area allocated to that user; and

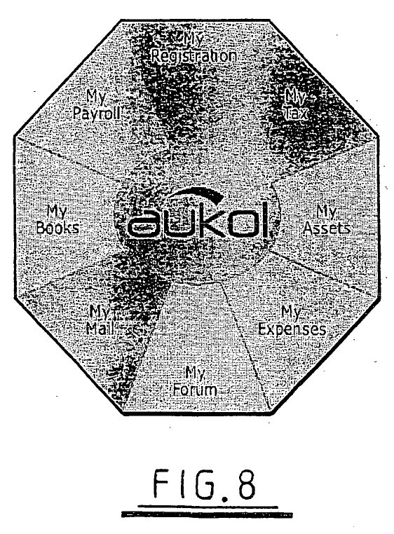

FIG. 8 is a schematic illustration of applications which may be provided to a user by an FRSP, in a system in accordance with the present invention;

Referring to FIG. 1, an FRSP 1 operating a computer system in accordance with the present invention including a database 2 is coupled via an Internet Service Provider (ISP) 3 to the Internet represented by the space 4. The FRSP offers to users a financial records storage package and offers to FSPs such as accountants the facility of providing services to users of the service provided by the FRSP. Users wishing to take up the service connect via the Internet to the FRSP, such users being indicated by boxes 5. Similarly, FSPs 6 interested in providing services to users of the FRSP's system are also coupled via the Internet to the FRSP 1. Such an arrangement means that there will be no communication between users, or between FSPs, or between users and FSPs, other than via the FRSP 1.

In the described system the FRSP makes itself available on the Internet via the ISP 3. It would of course be possible for the FRSP to become an ISP itself in which case the FRSP 1 would be connected directly to the Internet.

In the system of FIG. 1, users can subscribe to services including specific applications software made available by the FRSP. Alternatively, users may download applications to the FRSP to serve as the basis for the records to be kept by the FRSP on their behalf. Similarly a user may authorise an FSP to download particular applications to the FRSP on their behalf. A user may do no more than make use of the FRSP for the maintenance of financial records. In such cases no FSP would be given access to that user's financial records. Generally however, a user will authorise one or possibly more FSPs to have access to the financial records of that user and indeed may authorise an FSP to have the ability to both read and write data to the storage area of the database 2 which is allocated to that user.

Referring to FIG. 2, this schematically represents information exchanges between a user 5, the FRSP 1 and an FSP 6. The user 5 is allocated a storage space area 7 within the overall database 2, that area 7 being used to store all relevant data required to maintain the financial records of the respective user. The user 5 may input data to storage area 7 via the FRSP and in addition may input application software to enable the FRSP to run applications appropriate to the user's needs. Similarly the FSP may read and write data to the area 7 and in addition may deliver application software to the area 7 via the FRSP. This might be the approach to adopt if as may be the case the FSP had an existing relationship with the user 5 before the user 5 subscribed to the service provided by the FRSP. In those circumstances it is quite likely that before the user subscribed to the service the FSP would already be running applications on behalf of the user and could download those applications directly to the FRSP so that the user could immediately begin using the service in a manner which will be familiar to the user.

Referring to FIG. 3, the FRSP system comprises file storage in the form of disc array 8 and is coupled to the Internet via a firewall 9 and a hub 10 which communicates with an e-mail server 11, a forum server 12, a web page server 13 and a backup web page server 14. Each of the servers 11 to 14 is connected by a further hub 15 to the disk array 8. The main processor server 16 and a backup main processor server 17 are coupled to the web page servers 13 and 14 and the hub 15.

The e-mail server 11 is separate from the forum server 12. The e-mail server 11 enables secure communication between a user and an FSP such as the user 5 and FSP 6 of FIG. 2. In contrast the forum server 12 enables communication between any two users, any two FSPs or any user and any FSP. Thus the forum server system enables an open exchange of ideas between all those communicating with the FRSP whereas the e-mail server 11 enables the secure exchange of data related to for example a particular user's accounts records.

The web page servers 13 and 14 do no more than handle the HTML access of the system. Data is passed between the servers 13 and 14 and the servers 16 and 17, the hub 15 and the servers 16 and 17 representing the secure section of the network the operation of which is determined by the main processors 16 and 17. The servers 13 and 14 may operate Microsoft ASP (Active Server Pages) software whereas the main processor servers 16 and 17 will operate application software specific to a particular user's requirements.

FIGS. 4 to 7 are flow diagrams illustrating the operation of one application related to the storage and manipulation of sales data. This application is described in some detail merely by way of example and it will be appreciated that there are many other applications that may be made available, for example an application enabling a user to change the recorded user details, an application related to tax such as value added tax, an application related to banking records, for example current accounts balances, deposit accounts transactions, or deposit account balance, or applications related to petty cash account transactions, petty cash balance summaries, nominal ledger entries, new customer records or customer modification, new supplier records or supplier modification and the like. In addition there will of course be security routines giving access to users only on the presentation of appropriate user name, user password and user pin numbers to prevent unauthorised access to financial records. In addition, transmitted data may be encrypted using any convenient encryption algorithm.

Referring to FIG. 4, this flow diagram represents the process followed to create a new invoice. The user selects an invoice recipient from a list of existing clients or sets up a new client record, enters purchase details by entering data onto a screen-based form, reviews the resultant invoice data including calculated tax and delivery charges, and enters and approved invoice onto the database. In FIG. 4, three databases are shown but it will be appreciated that all of those three databases will form component parts of the single storage area allocated to the particular user.

The functionality represented in FIG. 4 permits the user to create a new sales invoice to a client, preview it, and print it from the web browser window which is presented to the user. The user simply has to click a link from a main menu to launch a sales sub-menu, then from that sub-menu click a link to create a new invoice. The screen then displays a blank invoice form which may include company branding, such as a logo and the address of the user's company.

The user then is presented with a list of all existing clients and selects the intended recipient of the invoice from that list. This is automatically populated from the customer database. Selecting the recipient populates the name and address details shown on the invoice for the recipient from the record held in the customer database. The system also automatically generates an invoice number. The user merely enters the invoice data and then proceeds to complete the details of the invoice form which permits the user to enter details of each transaction for which the invoice is being generated. Fields such as quantity, unit price and description may be completed. A column of transaction totals will be automatically calculated by multiplying the quantity of goods or services by the unit price. These amounts will be net of VAT. The column of transaction totals will be summed, and the user may then enter amounts for delivery and a discount in pounds sterling or as a percentage. The system will then total the elements which make up the invoice, calculate the VAT element of the price, and generate the grand total for the invoice. The user then simply prints the invoice and it is stored within the system for later reference.

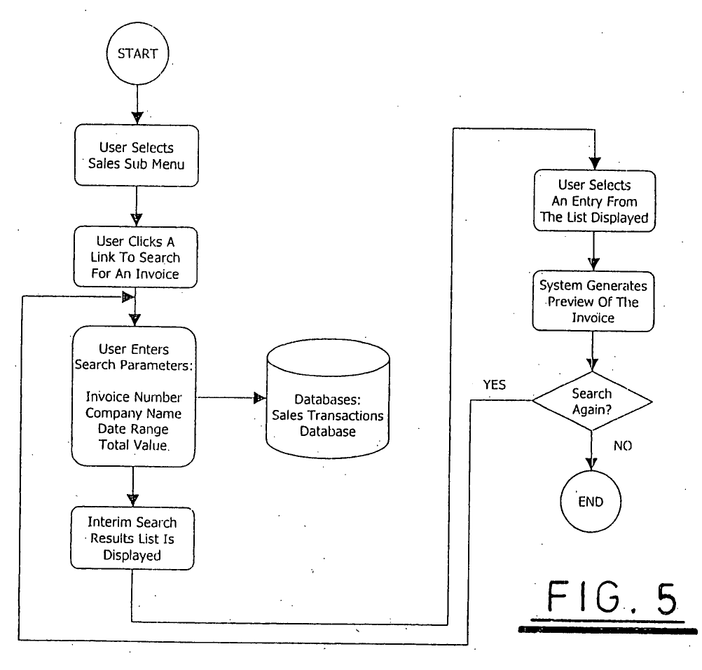

Referring to FIG. 5, this represents the routine followed to search for an existing invoice. The process represented in FIG. 5 enables the user to search for and display an existing invoice relying upon use of a dedicated search engine constructed for the website. The user selects the sales sub-menu from the main interface screen and, from the sales sub-menu, clicks a link to launch the invoice search engine. The user can enter the client name, invoice number, total amount range and a data range as search parameters. An interim search results screen is generated, which displays a table of results comprising the date, number, client name and invoice total for each located invoice. The user can then select an individual invoice from the list by clicking on it. The system will format and display the invoice within the browser window, from where the user may print it.

If the user does not locate the invoice of interest by performing such a search, the option is provided to return to the first screen of the invoice search engine and refine or expand the search criteria.

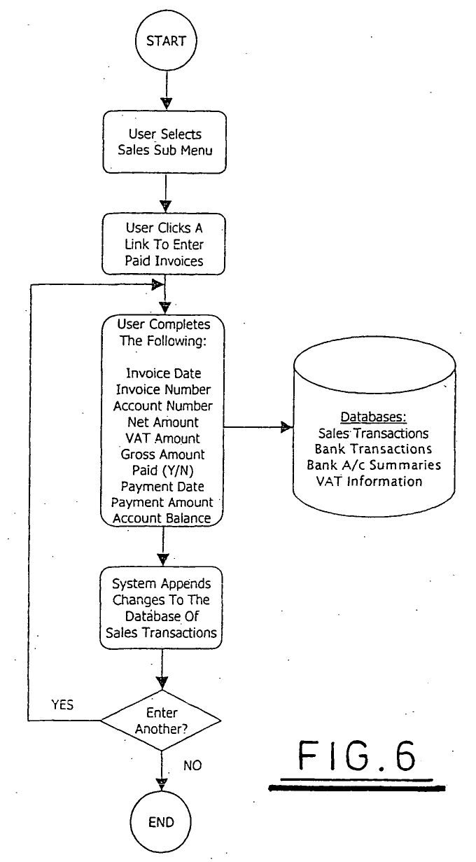

Referring to FIG. 6, this illustrates the routine followed to record payment of an existing invoice.

The functionality represented in FIG. 6 permits the user to enter paid invoices into a ledger. The ledger is designed in a manner which permits the user to enter part-payments on invoices and to log the outstanding balance on the system. Future payments on outstanding invoices can be offset against the outstanding balance until the amount due falls to zero.

The user selects the sales sub-menu from the main interface screen and from that sub-menu clicks a link to launch the paid invoices ledger. The screen displays a form with the following fields:

Date

Invoice Number

Account Number

Net Amount

VAT Amount

Gross Amount

Paid (Boolean)

Payment Date×4

Balance Outstanding

The user completes each entry as required and then clicks a button to append the transactions to the system databases. Linkages between the database of paid invoices, the VAT databases and the bank databases enables the transactions to be logged throughout the system where necessary.

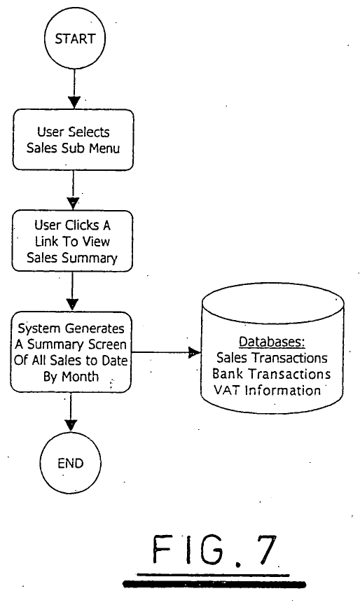

Referring to FIG. 7, this illustrates the routine followed to view a monthly sales summary.

The functionality illustrated in FIG. 7 permits the user to view a summary of monthly sales on a single screen. The user selects the sales sub-menu from the main interface screen and then clicks the link to launch the sales summary page. The summary is displayed within the Internet browser and shows monthly totals for all previous months processed on the system, and the current monthly total to date. The user may choose to print the summary simply by clicking on a link.

Given the use of a number of applications such as that described in an exemplary way with reference to FIGS. 4 to 7, it may be appreciated that a user may store in the allocated storage area as much or as little information as desired describing the operation of the user's business. The FSP may be instructed simply to read that data at appropriate intervals and at least annually to produce for example an audit report, or may be instructed to actively monitor the recorded data in a manner that one would expect a financial director in a large company to monitor the management information systems of such a company. For example, an FSP may monitor trends on expenses such as payroll costs, or trends on cash flow, or trends on sales, bad debts or the like. Such monitoring can be effected in an extremely efficient manner given that the FSP can have direct access to and can analyse exactly the same information as the user. In addition the FSP may for example correct errors in the recorded data and communicate the actions taken using the e-mail facility which is part of the overall system. A level of interaction and system sophistication can be delivered which is equivalent to the sort of Intranet systems used by large companies without massive expenditure on the necessary infrastructure by either the user or the FSP, given that the necessary infrastructure is provided by the FRSP.

It has been described above that the FRSP may provide a variety of different applications which can be accessed by users. Referring to FIG. 8, a preferred embodiment of the present invention is schematically illustrated. Here the FRSP provides a user with eight applications which may be used to manage their financial affairs. It will be appreciated that alternative embodiments of the invention may provide users with different applications from those illustrated.

By way of example, the process of creating a new account for a user will now be described in detail. The FRSP has access to a menu driven system. A main menu includes a “New Users Report” function, the selection of which provides the FRSP with a list of new users. The FRSP then selects an “edit” option adjacent to one of the new user accounts which is to be processed. This selection results in all account information relating to that user's account (as was input by the client) being displayed to the FRSP. The FRSP proceeds to verify this information, and then to obtain payment from the user in respect of the account creation. This payment can suitably be obtained using credit card details. Payment for use of the system is typically made annually, and the amount required is based upon the modules selected from those illustrated in FIG. 8. Thus the payment collected from the user is effectively an annual subscription.

When payment has been obtained, an “activate” option is selected by the FRSP so as to activate the user's account. Activating the account results in an invoice being issued, the account being enabled for use, and the account history being updated to show this activation.

The invoice can suitably be issued by generating an email which is sent to an email address provided by the user during the registration procedure. Typically, the email will contain the following details.

Subject: Order confirmation from AUKOL

Invoice Number

User address details

Salutation

Confirmation that payment has been made

Order details—list of the modules (as shown in FIG. 8) applied for, including module prices

Sales tax (VAT in the UK)

Total Charge

FRSP details

Enabling the user's account authorises the user to use the one or more modules illustrated in FIG. 8 which have been selected and subsequently paid for by the user. When the account is enabled an email is generated and sent to the user, the email contains the following:

Subject: AUKOL account change

Salutation

Link to a website providing access to the appropriate applications

Username

Password

Account Number

Updating the account history comprises updating the following information within a database storing details of user accounts:

Invoice Date

Invoice Number

Invoice Value Net

Invoice Value Sales Tax (VAT)

Invoice Value Gross

The FRSP is provided with functionality such that a user's account can be updated. For example a user may wish to purchase additional modules to those which were purchased at the time of account creation. If a user makes such a selection an email is automatically generated and sent to the FRSP, whereupon the user's account is given an “upgrade” status.

The FRSP can select a function to display all accounts having an “upgrade” status, and such a selection displays a selectable list such that the FRSP can select a particular account to edit. Selection of a particular account displays all the account information as input by the user. Typically the actions performed by the FRSP in response to the update of an account involve calculating the cost of the upgrade, which may be based on a pro-rata module rate taking into account the cost of that module for a twelve month period, and the number of months remaining until the entire account is due for renewal. This pro-rata rate is then invoiced to the user as described above. Following the generation of an invoice, enablement of the additional module, and the update to the user's account history, can then take place as described above.

As mentioned above, the FRSP will typically operate a system in accordance with the present invention on the basis that a user is required to pay an annual renewal fee so as to be able to use the appropriate modules provided by the FRSP. In a preferred embodiment of the invention, an email message is automatically generated 30 days before the account is due for renewal, and is sent to the user. The user then responds to this message confirming that renewal is desired. The FRSP then processes payment, enables the account for the appropriate period and updates the account history in the manner described above.

When using the system of the present invention as described above, a FSP is able to generate reports or documents from any standard accounting package, and provide a user with secure access to reports relating to his affairs via the Internet.

Typically, each user will access the system using a conventional desktop PC. The specification of this PC will typically be similar to that shown in table 1 below:

TABLE 1
System Requirements

| | |
|---|---|
| Computer/Processor: | 486DX/66 MHz or higher processor. |
| | Mouse |
| | CD-ROM |
| | Modem or Internet Connection |
| Operating System: | Windows 95, Windows 98, or |
| | Windows NT 4.0. If you are running a |
| | version of Windows NT, you must be |
| | running Windows NT Service Pack 3 |
| | or higher. |
| Memory: | For Windows 95 and Windows 98: |
| | 16 MB RAM minimum |
| | For Windows NT: |
| | 32 MB RAM minimum |
| Hard drive space: | Minimal install (browser-only): |
| | Required for install: 45 MB |
| | Required to run: 27 MB after restart |
| Typical install: | Required for install: 70 MB |
| | Required to run: 55 MB after restart |
| Full install: | Required for install: 111 MB |
| | Required to run: 80 MB after restart |

It will be appreciated that the above description of the system is intended only to outline preferred features and methods of implementation. Alternative implementations will be readily apparent to those skilled in the art.

1. A computer system for monitoring financial records for a plurality of users and for giving a plurality of mutually independent financial service providers selective access to the financial records, the system comprising a database partitioned into areas each of which is allocated to a respective user, a processor for writing data to and reading data from the database, computer network connections coupling the processor to each user and each financial service provider, a user access control system which is arranged to give a user access via the processor only to the respective data storage area such that each user can only update and read financial data stored in the respective data storage area, and a financial service provider access control system which is arranged to give a financial service provider at least read access via the processor to a data storage area only if that financial service provider is authorised by the user to which that data storage area has been allocated.

2. A computer system according to claim 1, wherein at least one of the partitioned storage areas of the database is supported on a discrete memory storage device to which the only user to have access is the user to which that storage device has been allocated.

3. A computer system according to claim 1, wherein a financial service provider may be authorised by a user to have write access to a user's data storage area.

4. A computer system according to claim 1, comprising e-mail infrastructure to enable the secure exchange of messages between a user and a financial service provider authorised to access the data storage area allocated to that user.

5. A computer system according to claim 1, comprising infrastructure to enable the open exchange of messages between users and financial service providers having access to storage areas of the database.

6. A computer system according to claim 1, wherein the processor runs applications functionally supporting at least one of the following services: payroll, sales, customer records, tax, bank accounts, credit card accounts, petty cash, supplier records, pensions, cash flow and budgets.

7. A computer system according to claim 6, wherein applications to be accessed by a user may be input by that user or a financial service provider authorised by that user.

8. A computer system according to claim 1, wherein the network connections are established via the Internet.

9. A method for maintaining financial records for a plurality of users and for giving a plurality of mutually independent financial service providers selective access to the financial records, wherein a database is established and partitioned into areas each of which is allocated to a respective user, a processor is connected to the database for writing data to and reading data from the database, the processor is coupled by network connections to the users and financial service providers, users are given access via the processor only to storage areas allocated to them, and financial service providers are given access via the processor to a storage area only when authorised by the respective user.

10. Cancelled.

11. Cancelled.
